(19) United States
(12) Patent Application Publication
(10) Pub. No.: US 2010/0174892 A1
(43) Pub. Date: Jul. 8, 2010

(54) MULTIPROCESSOR SYSTEM AND METHOD FOR SYNCHRONIZING A DEBUGGING PROCESS OF A MULTIPROCESSOR SYSTEM

(75) Inventor: Uwe Steeb, Dresden (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/438,119

(22) PCT Filed: Aug. 20, 2007
(86) PCT No.: PCT/IB2007/053313

§ 371 Date: Feb. 19, 2009

(30) Foreign Application Priority Data
Aug. 21, 2006 (EP) 06119260.5
Aug. 20, 2007 (IB) PCT/IB2007/053313

(51) Int. Cl. G06F 9/30

(52) U.S. Cl. 712/227; 712/E09.032

(57) ABSTRACT

The invention relates to a method and a system for synchronizing a debugging process of a multiprocessor system (1) with a number of processors (2.1 to 2.3), comprising the following steps: —if for one of the processors (2.1 to 2.3) a debugging process is requested by a STOP-signal (STOP#2.1 to STOP#2.3) a HALT-signal (HALT#2.1 to HALT#2.3) to the other processors (2.1 to 2.3) is asserted until their STOP-signal (STOP#2.1 to STOP#2.3) for debugging request is asserted to them, —asserting a respective HALT-signal (HALT#2.1 to HALT#2.3) to each processor (2.1 to 2.3) which has finished the debugging process until the other processors (2.1 to 2.3) have finished their respective debugging processeS, —starting all processors (2.1 to 2.3) synchronously after all HALT-signals (HALT#2.1 to HALT#2.3) and/or STOP-signals (STOP#2.1 to STOP#2.3) are de-asserted and all debugging processes are finished.

The invention relates to a method and a system for synchronizing a debugging process of a multiprocessor system.

In the development of a computer system the debugging of the hardware and/or software is a complex task. This task is even more difficult and complex for a multiprocessor system. Usually, one or more microprocessors or digital signal processors are integrated on a System-on-a-Chip (shortly called SoC) including a selection of memories such as ROM, RAM, EEPROM, peripherals including counter-timers, real-time timers, power supply, external interfaces such as USB, Ethernet, FireWire, and analog interfaces, etc. When debugging such a multiprocessor system, in case a fault has occurred in one of the processors, it is desirable to halt the other processors so that the error data will not be spread by the communication network. For instance, when debugging multiple processors with multiple debuggers following different problems occur:
When a debugger gives the run command for a first processor, then the system-on-a-chip synchronizing hardware detects this and stops the first processor until the second processor gets the run command.
Debuggers assert STEP- and RUN-signals when a user gives a RUN-command. This behaviour is typical when a debugger starts the processor from a previously hit breakpoint. Inside the system-on-chip, this sequence looks like two independent RUN-commands. With a simple implementation of processors synchronization the second processor starts upon the first step command of the first processor and stops after the step has finished which is not the anticipated behaviour. These “false alarms” should be prevented.

Furthermore, standard debuggers are involved on the host side of the system-on-chip which are not designed for multi-core debugging and are not aware of other processors or debuggers attached to the system-on-chip. A usual problem during starting and stopping processors and peripherals in such a multiprocessor system when debugging one processor is that a user wants to check what the second processor did at the time when the first processor hit the stop condition. Furthermore, the second processor might change the state of the system while the system is debugged and might run into a timeout while waiting for a response from the first processor and thus start again after debugging has failed. Peripherals like a DMA controller (DMA=direct memory access) or a timer can also change the state of the system in case they keep running while the system is debugged. Therefore, a synchronized running and stopping of processors is desired.

In the JP 222 87 42 A1, a synchronized debugging method for a plurality of processors is described. For example, at the time of storing the trace information, for example, a processor outputs an interrupt signal to an interrupt signal line and sends it to the other processors. Consequently, the other processors periodically and simultaneously receive this interrupt signal and simultaneously store the synchronizing signal mark in their own trace memories as trace information. Then, synchronizing signal marks which are not deviated from one another with respect to time are stored and held in trace memories of processors. Thus, the time lag between histories of the execution program of processors is eliminated, and they are synchronized with one another to execute safe debugging. These synchronized debugging method uses interrupt signal and synchronizing signal mark and trace information without synchronized starting and stopping of the processors.

Therefore, it is an object of the invention to provide a method and a system for synchronizing a debugging process of a multiprocessor system which provides synchronizing mechanisms inclusive of making the running, stopping and debugging of the processor aware to each other.

The given problem is solved by a method for synchronizing a debugging process of a multiprocessor system comprising the features given in claim 1 and by system comprising the features given in claim 9.

Advantageous embodiments of the invention are given in the respective dependent claims.

According to the invention a method for synchronizing a debugging process of a multiprocessor system with a number of processors is given, comprising the following steps:
if for one of the processors a debugging process is requested by a STOP-signal a HALT-signal to the other processors is asserted until their STOP-signal for debugging request is asserted to them,
asserting a respective HALT-signal to each processor which has finished the debugging process until the other processors have finished their respective debugging processes,
starting all processors synchronously after all HALT-signals and/or STOP-signals are de-asserted and all debugging processes are finished.

Such an implementation of a HALT-signal in addition to the regular STOP-signal for a debugging request (=shortly called DBREQ-signal) allows a synchronized start of a processor if the processor is really permitted to run, otherwise said HALT-signal is asserted. Furthermore, the HALT-signal allows a synchronized stopping. A regular debugger, such as a so called AxD or gdb-debugger for instance works in steps and then run when a user gives a RUN command. This behaviour is typical when a debugger starts the processors from a breakpoint and when breakpoints are implemented by inserting “break-instructions” into the debugging code. E.g. the debugger steps over the breakpoint, sets the breakpoint again and then runs the processor. For synchronized stopping, the other processors start upon the first STEP command of the debugger and stop them after the STEP has finished. When the debugger now gives the final RUN command, the other processors are already in debug mode again. To detect whether a processor has stopped and in addition whether its respective debugger has finished the debugging process the STOP-signal of the remaining processors have to be asserted. In case a processor has stopped, while the debugger and debugging process is still interacting, only the additional HALT-signals are asserted. The solution by said HALT-signal and two cross trigger matrices proposed and described below makes the assumption that fast toggling of a debugging mode signal (=shortly called DBGMODE) indicates “automatic debugger interaction” and slow toggling indicates “user interaction”. Said HALT-signal can be divided into a pre-HALT-signal and a post-HALT-signal. The pre-HALT-signal stops on the respective processor/s which is/are not in a debugging mode if one single processor is already in a debugging mode. The post HALT-signal stops on the respective processor/s which has/have finished the debugging process until the other processors have finished the debugging process.

In a possible embodiment a pre-HALT-signal of the respective processor is de-asserted if a STOP-signal requesting the debugging process of this respective processor is asserted. In other words: The STOP-signals are prioritized over the HALT-signals, i.e. when a STOP-signal is asserted, the respective HALT-signal is disabled.

In an alternative sophisticated embodiment, a pre-HALT-signal of the respective processor is de-asserted until a timer and/or counter have counted down from a predetermined value to a zero value. In another sophisticated embodiment, a STOP-signal of the respective processor is asserted when the pre-HALT-signal of this processor has been asserted for a predetermined time and/or a predetermined number of iterations. The STOP-signals are only asserted, when the respective HALT-signals are stable over a “sufficient time period” or when a STOP_SETTLED-bit is written, e.g. via a bus system. The detection of the actual time or the status of the STOP_SETTLED-bit can be done automatically by an internal timer or counter or externally e.g. on the host side, e.g. by a controller or debugging monitor.

In a further embodiment a STOP-signal and also an asserted HALT-signal of the respective processor is de-asserted if a debugging process is requested for this processor. The debugging process can be requested by asserting the debugging mode signal (=shortly called DBGMODE) by the respective processor or by asserting the debugging mode flag via a bus system by a debugging monitor, which is running on the processor.

Advantageously, a post-HALT-signal of the respective processor is de-asserted until each processor enters a RUN-state. In particular, if all processors have finished their debugging mode the post-HALT-signal of the respective processor which has finished his debugging mode earlier is de-asserted. This feature of the invention allows a synchronized run of all processors.

In an advantageous embodiment, two cross trigger matrices are implemented. A HALT-matrix and a STOP-matrix are implemented to generate the above described HALT-signals and/or STOP-signals. Both matrices comprise debugging mode signals as input signals for each processor which generate HALT-signals or STOP-signals as output signals for each processor.

The technical solution to achieve the object of this invention includes a system for synchronizing a debugging process of a multiprocessor system with a number of processors, comprising:
two cross trigger matrices comprising debugging mode signals as input signals for each processor and STOP-signals and HALT-signals as output signals for each processor,
one of said cross trigger matrices assert a HALT-signal to the other processors if for one of the processors a debugging process is requested by a STOP-signal of the other cross trigger matrix and until a respective STOP-signal for debugging request is asserted to said other processors by the other cross trigger matrix,
said cross trigger matrix asserts a respective HALT-signal to each processor, which has finished the debugging process until the other processors have finished their respective debugging processes,
all processors synchronously start after all HALT-signals and/or STOP-signals are de-asserted and all debugging processes are finished.

In said debugging system, advantageously each processor is connected with said two cross trigger matrices over at least three data lines comprising a line for said HALT-signal, a line for said STOP-signal and a line for a debugging mode signal. For detecting and providing a debugging process mode and/or request each processor is connected with a respective debugger module.

The present invention has the advantages of a simple synchronized debugging method for a multiprocessor system by using two cross trigger matrices to assert or de-assert an additional HALT-signal for synchronously starting and/or stopping of the processors during debugging mode of one or more processors.

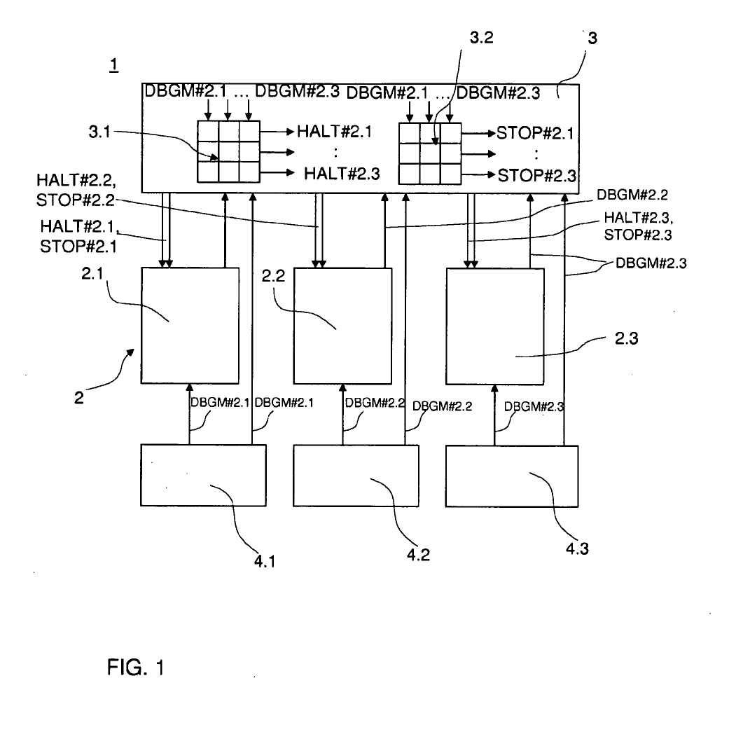

FIG. 1 shows a block diagram of a system for synchronizing a debugging process of a multiprocessor system with three processors comprising two cross trigger matrices,

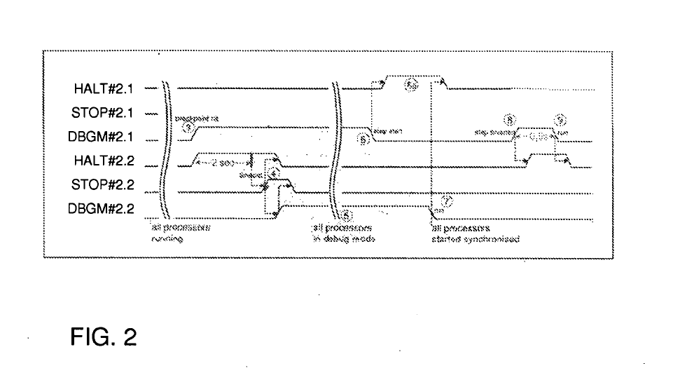

FIG. 2 shows a state transition diagram of the output signals of the two cross trigger matrices for a multiprocessor system with two processors.

The present invention is described in more detail.

FIG. 1 shows a block diagram of a system 1 for synchronizing a debugging process of a multiprocessor system 2 comprising three processors 2.1 to 2.3. The system 1 comprises a cross trigger logic 3 with two cross trigger matrices 3.1 and 3.2. One cross trigger matrix 3.1 is to generate a HALT-signal HALT#2.1 to HALT#2.3 for the respective processor 2.1 to 2.3 from a respective debugging mode signal DBGM#2.1 to DBGM#2.3. The other cross trigger matrix 3.2 is to generate a STOP-signal STOP#2.1 to STOP#2.3 for the respective processor 2.1 to 2.3 from a respective debugging mode signal DBGM#2.1 to DBGM#2.3.

In the debugging system 1 each processor 2.1 to 2.3 is connected with said two cross trigger matrices 3.1 and 3.2 over at least three data lines comprising a line for said HALT-signals HALT#2.1 to HALT#2.3, a line for said STOP-signals STOP#2.1 to STOP#2.3 and a line for said debugging mode signals DBGM#2.1 to DBGM#2.3. For detecting a respective debugging process mode and/or providing debugging process request each processor 2.1 to 2.3 is connected with a respective debugger module 4.1 to 4.3.

The debugging mode signal DBGM#2.1 to DBGM#2.3 can be asserted by a respective debugger 4.1 to 4.3 of the processors 2.1 to 2.3. Alternatively, the debugging mode signal DBGM#2.1 to DBGM#2.3 can be asserted via the respective processor 2.1 to 2.3 by asserting a debugging mode flag through a debugging monitor.

The invention relates to a method for synchronizing the debugging process of said multiprocessor system 2. A possible embodiment of the debugging method is described now in more detail with a state transition diagram for a multiprocessor system 2 comprised two processors 2.1 to 2.2 using a cross trigger logic 3 for cross triggering and synchronized starting and stopping of said two processors 2.1 to 2.2.

FIG. 2 shows a possible embodiment of a state transition diagram of the output signals HALT#2.1 to HALT#2.2 and STOP#2.1 to STOP#2.2 of the two cross trigger matrices 3.1 and 3.2 for a multiprocessor system 1 with two processors 2.1 and 2.2.

To synchronize the processors 2.1 and 2.2 each other during debugging process, there are the following different sophisticated steps and timing points:

Point 1: Both processors 2.1 and 2.2 are running.

Point 2: The cross trigger logic 3 is advantageously configured to generate HALT-signals HALT#2.1 to HALT#2.2 and STOP-signals STOP#2.1 to STOP#2.2 in case a debugging mode signal DBGM#2.1 to DBGM#2.2 is asserted for one of the processors 2.1 to 2.2. The STOP-matrix 3.2 is configured for instance to generate STOP-signals STOP#2.1 to STOP#2.2 in case the respective HALT-signals HALT#2.1 to HALT#2.2 are asserted for at least 2 seconds.

Point 3: For the processor 2.1 the debugging mode signal DBGM#2.1 is asserted. If the debugging mode signal DBGM#2.1 is set the processor 2.1 hits a breakpoint during the debugging process and a respective HALT-signal HALT#2.2 is asserted to the other processor 2.2. The processor 2.2 is now in a halt state and is stopped. The processor 2.1 is in a debugging process.

Point 4: The respective HALT-signal HALT#2.2 for the processor 2.2 can be de-asserted after an internal and/or external timer or counter have counted down from a predetermined value, e.g. from 2 seconds, to a zero value. Additionally or alternatively, the respective HALT-signal HALT#2.2 is de-asserted by a respective STOP-signal STOP#2.2 of the respective processor 2.2 which requests the debugging process of said processor 2.2 and which is automatically asserted after the timer or counter have reached the zero value or if a user has set the debugging process mode flag. The asserted STOP-signal STOP#2.2 requesting the debugging process of the respective processor 2.2 asserts the debugging mode signal DBGM#2.2 in the cross trigger logic 3. Both, the processor 2.2 and the processor 2.1 are now running in a debugging process.

Point 5: Both processors 2.1 to 2.2 communicate with their debuggers 4.1 to 4.2 and vice versa during the activated debugging processes.

Point 6: The Debugger 4.1 gives a run command RUN, which results in a step and a run command for the respective processor 2.1. The processor 2.1 runs from a breakpoint.

Point 6a: The step command of the debugger 4.1 normally de-asserts the debugging mode signal DBGM#2.1. Because the other processor 2.2 is still in a debugging process a HALT-signal HALT#2.1 for the respective processor 2.1 is asserted until said processor 2.2 has finished his respective debugging process. The processor 2.1 stays in a halt state until the processor 2.2 has finished his respective debugging process. The step command from the debugger 4.1 can not provided until the processor 2.1 is in a run state. The debugger 4.1 waits for a response to start the step command.

Point 7: The debugger 4.2 of the respective processor 2.2 asserts a run command. The debugging mode signal DBGM#2.2 is de-asserted with said run command of the debugger 4.2. The HALT-signal HALT#2.1 of the respective processor 2.1 is also de-asserted until said processor 2.2 enters a RUN-state. All processors 2.1 and 2.2 are in a RUN-state.

Point 8: The debugger 4.1 is set a request. Processor 2.1 goes into a debugging mode again. After the step command has finished, the debugging mode signal DBGM#2.1 and the HALT-signal HALT#2.1 for the other processor 2.1 is asserted.

Point 9: The debugger 4.1 set the run command to make the run from breakpoint for the processor 2.1 complete. The debugging mode signal DBGM#2.1 and the HALT-signal HALT#2.2 are de-asserted and both processors 2.1 and 2.2 are synchronously started. Because the debugger 4.1 sets the run command for instance in less than 2 seconds after the debugging mode signal DBGM#2.1 was asserted, the respective debugging mode signal DBGM#2.2 is not asserted.

In summary, the HALT-signals HALT#2.1 to HALT#2.3 are used for stopping the processors 2.1 to 2.3 each other. The respective HALT-signal HALT#2.1 to HALT#2.3 is replaced with the respective STOP-signal STOP#2.1 to STOP#2.3 when the respective debugger 4.1 to 4.3 has finished the debugging process and automatic interaction with the respective processor 2.1 to 2.3. At this point, the debugger 4.1 to 4.3 and the processor 2.1 to 2.3 are waiting for a user input. When the debuggers 4.1 to 4.3 are set the respective processors 2.1 to 2.3 in a RUN-state one after another, the HALT-matrix 3.1 prevents them from actually executing until the last processor 2.1 to 2.3 has finished his debugging process and enters in the RUN-state.

1. Method for synchronizing a debugging process of a multiprocessor system with a number of processors, comprising the following steps:
if for one of the processors a debugging process is requested by a STOP-signal a HALT-signal to the other processors is asserted until their STOP-signal for debugging request is asserted to them,
asserting a respective HALT-signal to each processor which has finished the debugging process until the other processors have finished their respective debugging processes,
starting all processors synchronously after all HALT-signals and/or STOP-signals are de-asserted and all debugging processes are finished.

2. Method according to claim 1, wherein a HALT-signal of the respective processor is de-asserted if a STOP-signal requesting the debugging process of this respective processor is asserted.

3. Method according to claim 1, wherein a HALT-signal of the respective processor is de-asserted until a predetermined timer and/or counter have reached a zero value.

4. Method according to claim 1, wherein a STOP-signal of the respective processor is asserted when the HALT-signal of this processor has been asserted for a predetermined time and/or a predetermined number of iterations.

5. Method according to claim 1, wherein a STOP-signal of the respective processor is asserted if a debugging process is requested for this processor.

6. Method according to claim 1, wherein a HALT-signal of the respective processor is de-asserted until each processor enters a RUN-state.

7. Method according to claim 1, wherein a HALT-signal and a STOP-signal for a respective processor are de-asserted if this processor runs in a debugging process.

8. Method according to claim 1, wherein two cross trigger matrices are implemented comprising debugging mode signals as input signals for each processor which generate HALT-signals and STOP-signals as output signals for each processor.

9. System for synchronizing a debugging process of a multiprocessor system with a plurality of processors, comprising:
two cross trigger matrices comprising debugging mode signals as input signals for each processor and STOP-signals and HALT-signals as output signals for each processor,
one of said cross trigger matrices asserts a HALT-signal to the other processors if for one of the processors a debugging process is requested by a STOP-signal of the other cross trigger matrix and until a respective STOP-signal for debugging request is asserted to said other processors by the other cross trigger matrix,
said cross trigger matrix asserts a respective HALT-signal to each processor, which has finished the debugging process until the other processors have finished their respective debugging processes,
all processors synchronously start after all HALT-signals and/or STOP-signals are de-asserted and all debugging processes are finished.

10. System according to claim 9, wherein each processor is connected with said two cross trigger matrices over at least three data lines comprising a line for said HALT-signal, a line for said STOP-signal and a line for a debugging mode signal.

11. System according to claim 9, wherein each processor is connected with a respective debugger module.
